(19) United States
(12) Patent Application Publication
(10) Pub. No.: US 2025/0253762 A1
(43) Pub. Date: Aug. 7, 2025

(54) CASCODE NORMALLY OFF SWITCH WITH DRIVER AND SELF BIAS

(71) Applicant: Transphorm Technology, Inc., Goleta, CA (US)

(72) Inventors: Tushar H. Dhayagude, San Jose, CA (US); Henry Frazier Pruett, North Bend, OR (US)

(21) Appl. No.: 18/853,241

(22) PCT Filed: Mar. 15, 2023
(86) PCT No.: PCT/US2023/064447

§ 371 Date: Oct. 1, 2024

Related U.S. Application Data
(60) Provisional application No. 63/337,979, filed on May 3, 2022.

(51) Int. Cl. H02M 1/36; H02M 1/00; H02M 1/088

(52) U.S. Cl. CPC H02M 1/36; H02M 1/0006; H02M 1/088

(57) ABSTRACT

An electronic component comprises a semiconductor devices package. The semiconductor device package includes a conductive structural package base, a first terminal configured to be connected to an inductive load, and a second terminal configured to be connected to a common node or circuit ground. The package further comprises an enhancement-mode transistor and a depletion-mode III-N transistor in a cascode configuration. The enhancement-mode transistor is monolithically integrated with an IC controller and a gate driver on a common silicon substrate, where an anode of a rectifying diode is connected to the drain of the enhancement-mode transistor and a cathode of the rectifying diode is connected to a voltage input terminal of the IC controller, and a reservoir capacitor has a first terminal connected to the cathode of the rectifying diode and a second terminal connected to the conductive structural package base.

### TECHNICAL FIELD

The disclosed technologies relate to semiconductor electronics and circuits designed for power conversion and related systems.

### BACKGROUND

Power converters are commonly used to convert one DC voltage level to another DC voltage level or to convert AC voltage to a DC voltage. The desire to improve power conversion efficiency is growing with the increasing demand and requirements for electronic systems such as mobile devices, computers, power supplies and electric vehicles. Consumer electronics are typically made without having an internal power supply and instead are powered by a small power supply that is directly built in the AC plug. These power supplies can draw some power (e.g., from the wall) even when they are supplying no power to a load (e.g., such as a phone). Switched power converters use active elements (e.g., Bi-polar Junction Transistors) which repeatedly draw energy even when the system is “offline” or idle. This energy draw can be high considering how many of these type of power converters are in use, and considering the fact that they are rarely unplugged or disconnected from the input power. Typical topologies used in switched power converters are forward, flyback, boost and buck converters.

Switched power converters typically require a low-voltage control circuit, such as an integrated circuit (e.g., an IC controller), that can turn on and off a primary power device, such as a power MOSFET, in response to the required output voltage and current of the power converter. FIG. 1 shows a switching power supply of the prior art. As seen in in FIG. 1, the power stage in the switching power supply 100 has several main elements, including a power switch 10 (such as a silicon MOSFET), an IC controller 11 that generates a signal (e.g., at a Pulse Width Modulation pin) to turn the power switch “ON” and “OFF”, and a gate drive circuit 12 (e.g., an amplifier) to apply the signal to power switch 10. The power supply 100 can include a Current Sensing (CS) connecter 13 with one side connected to the source of the power switch 10 and the other side connected to the CS pin of the IC controller 11. The current sensing connector can have a resistive element 14 connected between the current sense node connection at the power switch source and a common-node or ground rail. The power switch 10 is connected in series with an inductive element 15 such as an inductor or a transformer winding. The inductive element is connected to a positive input voltage 16, which can be an outlet or wall power (e.g., 120V or 240V or more). A second inductive component 19 is magnetically coupled to the first inductive component 15 and is used to generate the switching supply power to output terminal 18.

Offline power converters, such as when the power supply 100 is idle, present a challenge in starting up (or turning online) due to the mismatch in the high voltage input power 16 (e.g., from the wall) and the low voltage power requirements of the IC controller 11. Traditional power converters, such as the prior art of FIG. 1, use an array of components shown in the dashed area 110 to generate the V_{CC} input voltage (e.g., 12V-35V) to power or startup the IC controller 11. This array of components can include a high voltage Bi-Polar Junction (BJT) transistor 20, resistor 21, diode 22 (which can be a Zener diode), capacitor 23, resistor 24, Zener diode 25. In addition to the primary winding of the inductive component 15, the power supply 100 also includes auxiliary windings 17. The auxiliary windings 17 from the inductive component can generate energy to power the IC controller during normal operation, and the IC controller 11 input voltage V_{CC} requirements can be provided by the auxiliary windings 17 and regulated by resistor 26, diode 27 (which can be a Zener diode), and capacitor 28. A major drawback to using the startup circuitry shown in dashed area 110 for the power supply 100 is the use of the active component BJT transistor 20. When power supply 100 is used for high voltage applications, for example applications requiring 350V or more, significant power can be dissipated by the BJT switch 20, particularly when the power supply is idle. As a result, alternative designs to startup power converters are desired to improve converter efficiency and reduce costs.

### SUMMARY

Described herein are System in Package (SIP) configurations for which a low-voltage enhancement-mode device and a high-voltage depletion-mode III-N device are used to startup a power converter. The low-voltage enhancement-mode device, high-voltage depletion-mode III-N device, controller IC, gate driver, and startup components can be integrated into a single electronic component module. The term device will be used in general for any transistor or switch or diode when there is no need to distinguish between them.

In a first aspect, an electronic component is described. The electronic component includes a semiconductor device package. The semiconductor device package includes a conductive structural package base, a first terminal configured to be connected to an inductive load, and a second terminal configured to be connected to a common node or circuit ground. The package further comprises an enhancement-mode transistor and a depletion-mode transistor. The depletion-mode III-N transistor has a drain electrode, a source electrode, and a gate electrode. The enhancement-mode transistor has a drain electrode, a source electrode, and a gate electrode. The drain electrode of the depletion-mode III-N transistor is electrically connected to the first terminal, the source electrode of the depletion-mode III-N transistor is electrically connected to the drain electrode of the enhancement-mode transistor, the gate electrode of the depletion-mode III-N transistor is electrically connected to the conductive structural package base, the source electrode of the enhancement-mode transistor is electrically connected to the conductive structural package base. The enhancement-mode transistor is monolithically integrated with an IC controller and a gate driver on a common silicon substrate, where an anode of a rectifying diode is connected to the drain of the enhancement-mode transistor and a cathode of the rectifying diode is connected to a voltage input terminal of the IC controller, and a reservoir capacitor has a first terminal connected to the cathode of the rectifying diode and a second terminal connected to the conductive structural package base.

In a second aspect, an electronic circuit is described. The electronic circuit includes a first winding of an inductive component coupled to a high-voltage node, and a second winding of the inductive component is coupled to a drain of a high-voltage depletion-mode transistor. A drain of a low-voltage enhancement-mode transistor is electrically connected to the source of the depletion-mode transistor, the gate of the deletion-mode transistor is electrically connected to the source of the enhancement-mode transistor, and the source of the enhancement-mode transistor is connected to a circuit ground. The circuit further includes an IC controller comprising at least four pins, where the first pin is a voltage input pin, the second pin proves a pulse-width modulation out signal, the third pin is a current sense pin electrically connected to the source of the enhancement-mode transistor, and the fourth pin is electrically connected to the circuit ground. A gate drive includes an input connected to the second pin and an output connected to the gate of the enhancement-mode transistor, and an anode of a diode is electrically connected to the drain of the enhancement-mode transistor, a cathode of the diode is electrically connected to the IC controller input pin, and a first terminal of a capacitor is electrically connected to the cathode of the diode and a second terminal of the capacitor is electrically connected to the circuit ground, where the enhancement-mode transistor, the IC controller, the gate driver, the diode, and the capacitor are monolithically integrated in to a discrete semiconductor IC device.

In a third aspect, an electronic package is described. The electronic package includes a conductive structural package base, a first terminal, a second terminal, a first electronic component, and a second electronic component. The first electronic component includes a monolithically integrated circuit formed on a common silicon substrate. The monolithically integrated circuit includes an IC controller, a gate driver, a low-voltage enhancement-mode silicon MOSFET, and an IC controller startup circuit. The second electronic component includes a high-voltage depletion-mode GaN transistor with a gate-to-source threshold voltage, where a source electrode of the depletion-mode GaN transistor is electrically connected to the drain electrode of the enhancement-mode silicon MOSFET transistor. The first terminal is electrically connected to a drain electrode of the depletion-mode GaN transistor and the second terminal is electrically connected to the conductive structural package base. A gate electrode of the depletion-mode GaN transistor and a source electrode of the enhancement-mode silicon MOSFET transistor are electrically connected to the conductive package base, where a V_{CC} node of the IC controller is coupled to the drain electrode of the enhancement-mode silicon MOSFET within the monolithically integrated circuit.

The electronic circuits and/or transistors described herein can include one or more of the following features. The rectifying diode and reservoir capacitor can form an IC startup circuit, and the IC startup circuit can be monolithically integrated with the enhancement-mode transistor on a common substrate. The depletion-mode III-N transistor can be a high-voltage GaN HEMT with a breakdown voltage of greater than 600V and a gate-to-source threshold voltage of −15V or less. The enhancement-mode transistor can be a low-voltage silicon MOSFET device with a breakdown voltage greater than the absolute value of the depletion-mode transistors threshold voltage. The source electrode and the drain electrode of the depletion-mode III-N transistor can be on a first side of a III-N material structure over an electrically conductive substrate, and the gate electrode can be on a second side of the III-M a material structure opposite the first side.

The IC controller can include a ground terminal connected to the conductive structural package base, a current sense terminal electrically connected to the source electrode of the enhancement-mode transistor, and a gate drive terminal connected to the gate electrode of the enhancement-mode transistor. When the first terminal of the package is biased at a voltage greater than 300V, the second terminal of the package can be connected to circuit ground and the electronic component can be in the OFF state, the drain of the enhancement-mode transistor can maintain a positive voltage between +15V to +25V relative to the source electrode of the enhancement-mode transistor, and a startup voltage can be provided to the IC controller from the drain of the enhancement-mode transistor. The rectifying diode need not be a Zener diode.

The threshold of the GaN HEMT device can be less than −12V. The drain-to-source voltage of the enhancement-mode transistor can be greater than +10V when the electronic circuit is idle or offline. A startup voltage can be provided to the voltage input pin of the IC controller from the drain-to-source voltage of the enhancement-mode transistor when the circuit is idle or offline. The discrete semiconductor IC device and the GaN HEMT device can be assembled into a single electronic component package. The single electronic component package can include a conductive structural package base, and a substrate of the discrete semiconductor IC device and a substrate of the GaN HEMT device can be physically attached to the conductive structural package base. The IC controller startup circuit can include a diode and a capacitor coupled between the V_{CC} node and the drain electrode of the enhancement-mode silicon MOSFET. The drain-to-source voltage of the enhancement-mode silicon MOSFET can be biased at +12V or more when the depletion-mode GaN transistor is biased below the gate-to-source threshold voltage.

As used herein, a “hybrid enhancement-mode electronic device or component”, or simply a “hybrid device or component”, is an electronic device or component formed of a depletion-mode transistor and an enhancement-mode transistor, where the depletion-mode transistor is capable of a higher operating and/or breakdown voltage as compared to the enhancement-mode transistor, and the hybrid device or component is configured to operate similarly to a single enhancement-mode transistor with a breakdown and/or operating voltage about as high as that of the depletion-mode transistor. That is, a hybrid enhancement-mode device or component includes at least 3 nodes having the following properties. When the first node (source node) and second node (gate node) are held at the same voltage, the hybrid enhancement-mode device or component can block a positive high voltage (i.e., a voltage larger than the maximum voltage that the enhancement-mode transistor is capable of blocking) applied to the third node (drain node) relative to the source node. When the gate node is held at a sufficiently positive voltage (i.e., greater than the threshold voltage of the enhancement-mode transistor) relative to the source node, current passes from the source node to the drain node or from the drain node to the source node when a sufficiently positive voltage is applied to the drain node relative to the source node. When the enhancement-mode transistor is a low-voltage device and the depletion-mode transistor is a high-voltage device, the hybrid component can operate similarly to a single high-voltage enhancement-mode transistor. The depletion-mode transistor can have a breakdown and/or maximum operating voltage that is at least two times, at least three times, at least five times, at least ten times, or at least twenty times that of the enhancement-mode transistor.

As used herein, the terms III-Nitride or III-N materials, layers, devices, etc., refer to a material or device comprised of a compound semiconductor material according to the stoichiometric formula B_{w}AlₓIn_{y}Ga_{z}N, where w+x+y+z is about 1 with 0≤w≤1, 0≤x≤1, 0≤y≤1, and 0≤z≤1. III-N materials, layers, or devices, can be formed or prepared by either directly growing on a suitable substrate (e.g., by metal organic chemical vapor deposition), or growing on a suitable substrate, detaching from the original substrate, and bonding to other substrates.

As used herein, two or more contacts or other items such as conductive channels or components are said to be “electrically connected” if they are connected by a material which is sufficiently conducting to ensure that the electric potential at each of the contacts or other items is intended to be the same, e.g., is about the same, at all times under any bias conditions.

As used herein, a “drain electrode,” a “source electrode,” and a “gate electrode” refer to a portion of the source, drain or gate of the device which is used to be electrically connected to an outside structure or device. For example, a drain of a device can be electrically connected to another device by forming a wire-bond on the drain electrode.

As used herein, “blocking a voltage” refers to the ability of a transistor, device, or component to prevent significant current, such as current that is greater than 0.001 times the operating current during regular conduction, from flowing through the transistor, device, or component when a voltage is applied across the transistor, device, or component. In other words, while a transistor, device, or component is blocking a voltage that is applied across it, the total current passing through the transistor, device, or component will not be greater than 0.001 times the operating current during regular conduction. Devices with off-state currents which are larger than this value exhibit high loss and low efficiency, and are typically not suitable for many applications, especially power switching applications.

As used herein, a “high-voltage device”, e.g., a high-voltage switching transistor, HEMT, bidirectional switch, or four-quadrant switch (FQS), is an electronic device which is optimized for high-voltage applications. That is, when the device is off, it is capable of blocking high voltages, such as about 300V or higher, about 600V or higher, or about 1200V or higher, and when the device is on, it has a sufficiently low on-resistance (R_{ON}) for the application in which it is used, e.g., it experiences sufficiently low conduction loss when a substantial current passes through the device. A high-voltage device can at least be capable of blocking a voltage equal to the high-voltage supply or the maximum voltage in the circuit for which it is used. A high-voltage device may be capable of blocking 300V, 600V, 1200V, 1700V, 2500V, or other suitable blocking voltage required by the application. In other words, a high-voltage device can block all voltages between 0V and at least Vₘₐₓ, where Vₘₐₓ is the maximum voltage that can be supplied by the circuit or power supply, and Vₘₐₓ can for example be 300V, 600V, 1200V, 1700V, 2500V, or other suitable blocking voltage required by the application. For a bidirectional or four quadrant switch, the blocked voltage could be of any polarity less a certain maximum when the switch is OFF (±Vₘₐₓ such as ±300V or ±600V, 1200V and so on), and the current can be in either direction when the switch is ON.

As used herein, a “III-N device” is a device having a conductive channel formed in a III-N material. A III-N device can be designed to operate as a transistor or switch in which the state of the device is controlled by a gate terminal or as a two terminal device that blocks current flow in one direction and conducts in another direction without a gate terminal. The III-N device can be a high-voltage device suitable for high voltage applications. In such a high-voltage device, when the device is biased off (e.g., the voltage on the gate relative to the source is less than the device threshold voltage), it is at least capable of supporting all source-drain voltages less than or equal to the high-voltage in the application in which the device is used, which for example may be 100V, 300V, 600V, 1200V, 1700V, 2500V, or higher. When the high voltage device is biased on (e.g., the voltage on the gate relative to the source or associated power terminal is greater than the device threshold voltage), it is able to conduct substantial current with a low on-voltage (i.e., a low voltage between the source and drain terminals or between opposite power terminals). The maximum allowable on-voltage is the maximum on-state voltage that can be sustained in the application in which the device is used.

The terms “over,” “under,” “between,” and “on” as used herein refer to a relative position of one layer with respect to other layers. As such, for example, one layer disposed over or under another layer may be directly in contact with the other layer or may have one or more intervening layers. Moreover, one layer disposed between two layers may be directly in contact with the two layers or may have one or more intervening layers. In contrast, a first layer “on” a second layer is in contact with that second layer. Additionally, the relative position of one layer with respect to other layers is provided assuming operations are performed relative to a substrate without consideration of the absolute orientation of the substrate.

In typical power switching applications in which high-voltage switching transistors are used, the transistor is during the majority of time in one of two states. In the first state, which is commonly referred to as the “ON state”, the voltage at the gate electrode relative to the source electrode is higher than the transistor threshold voltage, and substantial current flows through the transistor. In this state, the voltage difference between the source and drain is typically low, usually no more than a few volts, such as about 0.1-5 volts. In the second state, which is commonly referred to as the “OFF state”, the voltage at the gate electrode relative to the source electrode is lower than the transistor threshold voltage, and no substantial current, apart from off-state leakage current, flows through the transistor. In this second state, the voltage between the source and drain can range anywhere from about 0V to the value of the circuit high voltage supply, which in some cases can be as high as 100V, 300V, 600V, 1200V, 1700V, or higher, but can be less than the breakdown voltage of the transistor. In some applications, inductive elements in the circuit cause the voltage between the source and drain to be even higher than the circuit high voltage supply. Additionally, there are short times immediately after the gate has been switched on or off during which the transistor is in a transition mode between the two states described above. When the transistor is in the off state, it is said to be “blocking a voltage” between the source and drain. As used herein, “blocking a voltage” refers to the ability of a transistor, device, or component to prevent significant current, such as current that is greater than 0.001 times the average operating current during regular on-state conduction, from flowing through the transistor, device, or component when a voltage is applied across the transistor, device, or component. In other words, while a transistor, device, or component is blocking a voltage that is applied across it, the total current passing through the transistor, device, or component will not be greater than 0.001 times the average operating current during regular on-state conduction.

The details of one or more disclosed implementations of the subject matter described in this specification are set forth in the accompanying drawings and the description below. Additional features and variations may be included in the implementations as well. Other features, aspects, and advantages will become apparent from the description, the drawings and the claims.

### DESCRIPTION OF DRAWINGS

FIG. 1 is a circuit schematic of a power converter of the prior art.

FIG. 2 is a circuit schematic of a hybrid III-N device in a cascode configuration.

FIG. 3 is a circuit schematic of a power converter using a cascode configuration.

FIG. 4 is a circuit schematic of a power converter with a monolithic integrated controller.

FIG. 5 is a circuit schematic of a system-in-package power converter.

FIGS. 6A and 6B are cross-sectional views of III-N deletion-mode power devices.

FIG. 7 is a plan view of a system-in-package power converter.

Like reference symbols in the various drawings indicate like elements.

### DETAILED DESCRIPTION

Described herein are System in Package (SIP) configurations for which a low-voltage enhancement-mode transistor and a high-voltage depletion-mode III-N transistor are used to startup a switched power converter. The low-voltage enhancement-mode transistor, high-voltage depletion-mode III-N transistor, controller IC, gate driver, and startup components can be integrated into a single electronic component package or module. Furthermore, the low-voltage device, the controller elements, and the startup components can be monolithically integrated and formed with a common IC substrate. The SIP can have a reduced component count and integrated efficiencies compared to traditional power conversion solutions, thereby allowing for lower production costs and improve system performance.

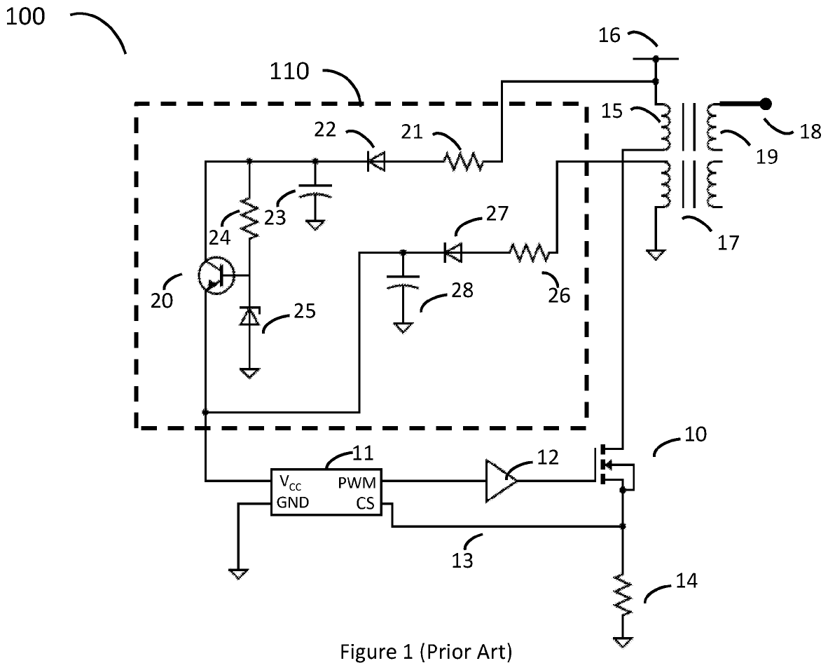

Typical power semiconductor devices, such as the power MOSFET 10 in FIG. 1, are fabricated with silicon (Si) semiconductor materials. More recently, wide-bandgap materials such as III-N materials have been considered for power devices due to their superior properties. III-Nitride or III-N semiconductor devices, such as gallium nitride (GaN/AlGaN) HEMT devices, are now emerging as attractive candidates to carry large currents, support high voltages, and provide very low on-resistance with fast switching times.

Most conventional III-N HEMTs and related transistor devices are normally on (i.e., have a negative threshold voltage), which means that they conduct current at zero gate-to-source voltage (V_{GS}). These devices with negative threshold voltages are known as depletion-mode (D-mode) devices. It is preferable in power electronics to have normally off devices (i.e. devices with positive threshold voltages), that are in the off state at zero V_{GS}, in order to prevent accidental turn-on of the device, which can lead to damage of the device or to other circuit components. Normally off devices are commonly referred to as enhancement-mode (E-mode) devices.

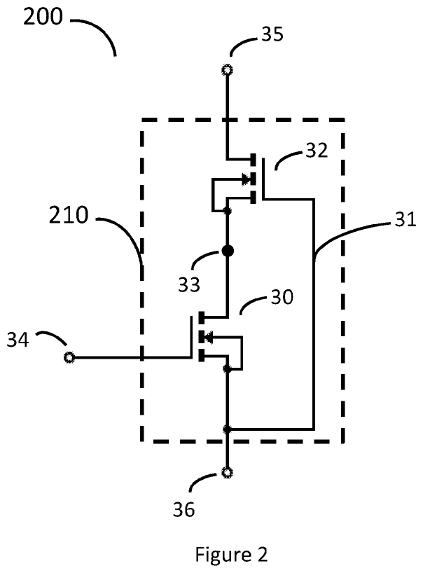

Reliable fabrication and operation of high-voltage E-mode III-N transistors has thus far proven to be very difficult. One alternative to a single high-voltage E-mode III-N transistor is to combine a high-voltage D-mode III-N transistor with a low-voltage silicon E-mode FET in a cascode configuration. As seen in FIG. 2, the cascode configuration 200 includes a high-voltage D-mode III-N device 32 and a low-voltage E-mode device 30 to form a hybrid III-N device 210. The source of the D-mode device 32 is electrically connected to the drain of E-mode device 30 at node 33. The gate of the D-mode device 32 is electrically connected to the source of the E-mode device 30 with connector 31. The gate of the E-mode device 30 can function as the gate electrode 34 of the hybrid device 210 and can be controlled by standard gate drive values, such as 1.6V to 20V. Devices that are configured in the cascode configuration 200 as shown in FIG. 2 can be operated in the same way as a single high-voltage E-mode transistor, with the drain of the D-mode device functioning as the drain electrode 35 of the hybrid device 210, the source of the E-mode device 30 functioning as the source electrode of the hybrid III-N device 210, and in many cases achieve the same or similar output characteristics as a single high-voltage normally-off transistor.

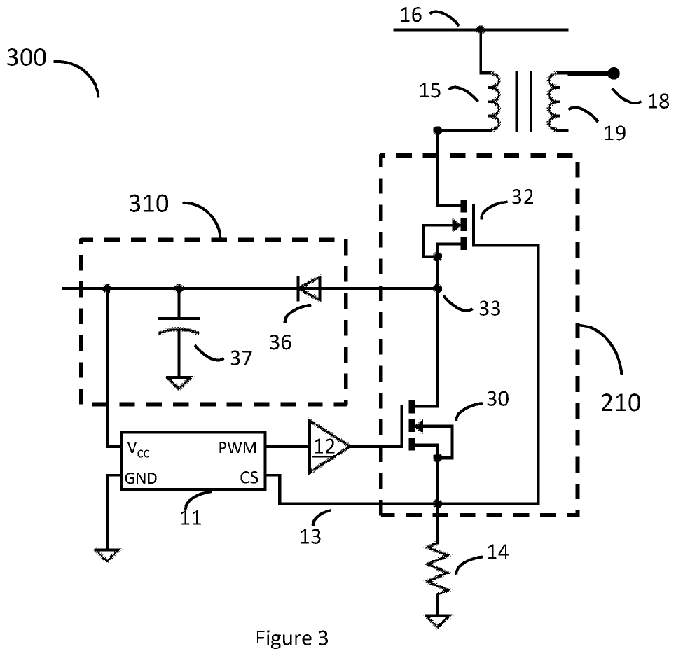

FIG. 3 shows a schematic diagram of a switching power supply 300 where the hybrid III-N device 210 of FIG. 2 is implemented in place of the power MOSFET 10 shown in FIG. 1. The hybrid III-N device 210 includes a high-voltage depletion-mode (D-mode) III-N device 32 such as a GaN HEMT transistor. The III-N device 32 can have a breakdown voltage greater than 600V and capable of supporting drain-source currents (I_{DS}) of greater than 15A.

The depletion-mode III-N device is a normally-on device, i.e., the device is turned “ON” when the gate-to-source voltage is biased at zero volts and the device is turned “OFF” when the gate-to-source voltage of the III-N device is biased at a negative voltage that is less than the threshold voltage of the device. For example, the III-N device 32 can have a substantially negative threshold voltage of −15V and the device can be biased “OFF” by biasing the gate-to-source voltage at −20V or less (where less is considered more negative). In some embodiments, the III-N device has a negative threshold voltage between −12V to −30V The required threshold-voltage of the III-N device 32 is critical to the startup voltage requirements of the power supply 300 and will be more clearly outlined further in this specification. The hybrid III-N device 210 includes a low-voltage enhancement-mode (E-mode) device 30 such as a silicon MOSFET transistor. The enhancement-mode device 30 can have a threshold voltage between 1.6V-6V. The breakdown voltage of the of the enhancement-mode device 30 can be greater than the absolute value of the threshold voltage of the depletion-mode III-N device 32. The depletion-mode III-N device 32 and the enhancement-mode device 30 can be co-packed into a single hybrid electronic component package.

The source of the III-N device 32 is electrically connected to the drain of the E-mode device 30 at node 33. The gate of the III-N device 32 is electrically connected to the source of the E-mode device 30 with connector wire 31. The switching power supply 300 includes an inductive component 15 with multiple windings (such as a transformer) each with a pair of terminals. A first terminal of the of the first windings of the inductive component 15 can be coupled to an input power supply 16 and the second terminal of the first windings is electrically connected to the drain of the III-N device 32. A second inductive component 19 is magnetically coupled to the first inductive component 15 and is used to generate the switching supply power to output terminal 18.

The gate of the low-voltage enhancement-mode device can act as the gate of the hybrid III-N device 210. A integrated-circuit (IC) controller 11 and gate driver 12 can be used to deliver the Pulse-Width-Modulation (PWM) signal to control the gate driving pattern to meet the output requirements of the power supply 300. The IC controller 11 can include at least 4 input/output pins or terminals. The first pin can be a voltage input pin or V_{CC}, the second pin can provide the PWM signal to the gate driver 12, the third pin can connect a current sense (CS) loop 13 to the source of the enhancement-mode device 30, and a fourth pin can be connected to a circuit ground or common node. Optionally, the current sense loop 13 can require a sense resister 14 configured between the current sense loop 13 and a common-node or circuit ground.

Switching power converters such as power supply 300 typically require a low-voltage control circuit, such as an IC controller 11, that can turn on and off the primary power device (i.e., hybrid device 210) in response to the required output voltage and output current of the power converter. The cascode configuration of the hybrid device 210 can easily provide the low-voltage startup requirements of the IC controller 11 when the power supply is “offline” or idle. For example, the IC controller 11 can require a +10 to +35 volt V_{CC} to start-up. When the hybrid device 210 is in the “OFF” state, the high-voltage D-mode III-N device is blocking the input voltage (e.g., from the wall) and the drain-to-source voltage of the E-mode device 30 settles around the absolute value of the threshold voltage of the D-mode III-N device 32. Since the gate of the D-mode device 32 is tied (i.e., electrically connected) to the source of the E-mode device 30, the gate voltage of the D-mode device 32 is essentially pinned at or near 0V. This means that if the D-mode device 32 has a negative gate-to-source threshold voltage of −15V, a voltage node 33 between the source of the D-mode device 32 and drain of the E-mode device 30 will be held at around +15V (relative to the source of the E-mode device 30) while the hybrid III-N device is biased in the “OFF” state. For example, the drain-to-source voltage of the E-mode device 30 can be maintained within +/−5 volts or +/−2 volts of the absolute value of the threshold voltage of the D-mode III-N device 32 when the D-mode III-N device is in the “OFF” state and blocking the high-voltage input supply. The voltage maintained at voltage node 33 (i.e., the gate-to-source voltage of the E-mode device 30) can sufficiently supply the voltage required to “start-up” the IC controller 11 when the power supply is “offline” or idle and the hybrid device 210 is blocking the high-voltage input supply.

The simplified required start-up circuitry of power supply 300 is shown in dashed region 310. An anode of a rectifying diode 36 can be electrically connected to the voltage node 33 between the source of the D-mode device 32 and the drain of the E-mode device 30. The cathode of diode 36 can be connected to a first terminal of a reservoir capacitor 37 and the V_{CC} input voltage terminal of the IC controller 11. The second terminal of the reservoir capacitor 37 can be connected to a common node or circuit ground. The rectifying diode 36 can be a standard p-n diode in circuit 300, compared to the Zener diode required in circuit 100. This can further improve circuit efficiency because Zener diodes are less energy efficient compared to standard p-n diodes due to dissipating power in reverse conduction mode. Therein, the voltage held between D-mode and E-mode devices of the cascode configured hybrid device in the “OFF” state is used to power the startup requirements of the IC controller 11. The value of the reservoir capacitor 37 can be chosen depending on the power consumption requirements of the IC controller 11. For example, the input voltage 16 can be greater than 600V and the III-N device 32 can be capable of “blocking” a voltage greater than the input voltage. When the hybrid device 210 is “blocking” the input voltage, the voltage at the source of the III-N device 33 can be, for example, around +15V and thereby used to power the startup of IC controller 11.

Compared to the startup circuitry shown in the dashed region 110 of FIG. 1, the complexity of power supply 300 is greatly reduced compared to the power supply 100 of FIG. 1 where the start-up voltage is drawn from the input voltage 16. Furthermore, the power loss can be reduced and efficiency can be increased by the elimination of the BJT transistor 20 of FIG. 1 (or a JFET or N-Channel start-up MOSFET) used to startup traditional switching power supplies. The active and passive component count for the startup circuitry 110 in FIG. 1 is at least 9 components, compared to the startup circuitry 310 shown in FIG. 3 which can be reduced to as few as two components (a diode and capacitor). The power supply 300 does not require the auxiliary windings 17 of the inductive component 15 shown in FIG. 1 to power the IC controller 11, which can contribute to a substantial size and weight increase of the power convert.

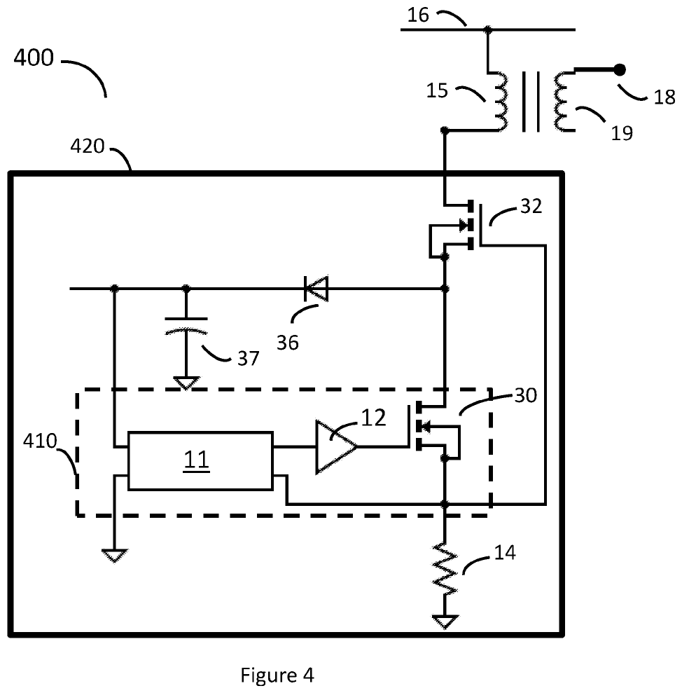

FIG. 4 shows a schematic diagram of a switching power supply 400. Power supply 400 is similar to power supply 300 of FIG. 3, except that power supply 400 includes a monolithic IC 410. Monolithic IC 410 includes the enhancement-mode FET device 30, the IC controller 11 and the gate driver 12 monolithically integrated and formed on a common device substrate (e.g., a silicon substrate). Optionally, monolithic IC 410 can also include the current sense resistor 14 integrated on the common substrate. Features of the power supply 400 can be assembled into a single electronic component package 420. Component package 420 can include a conductive structural package base (not shown) which is configured to be circuit ground. The depletion-mode III-N transistor 32, the monolithic IC 410, the rectifying diode 36, and the reservoir capacitor 37 can be mounted to the structural package base. The second terminal of capacitor 37 can be electrically connected to the package base.

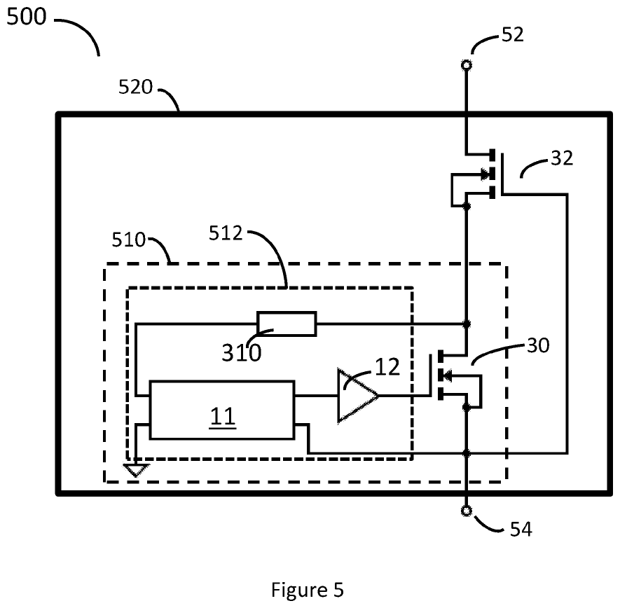

FIG. 5 shows a schematic diagram of a switching power supply 500. Power supply 500 is similar to power supply 400 of FIG. 4, except that power supply 500 includes a monolithic IC 510. Monolithic IC 510 is similar to monolithic IC 410 except that monolithic IC 510 further includes the required start-up circuitry (indicated by region 310) monolithically integrated into the same common substrate (e.g., a silicon substrate) as the IC controller 11, gate driver 12, and the E-mode device 30. To be clear, the monolithic IC 510 includes two distinct physical portions, i.e., distinct non-overlapping areas on the common substrate. The first portion includes the low-voltage enhancement-mode transistor 30, and the second portion 512 which includes the startup circuitry 310, the IC controller 11, and the gate driver 12. The startup circuitry 310 can include at least the diode 28 and the capacitor 25 shown in the dashed region 310 in FIG. 3. The anode of diode 28 is electrically connected and internally integrated with metal routing layers to the drain of the enhancement-mode device 30.

Furthermore, monolithic IC 510 and the depletion-mode III-N device 32 can be assembled into a single electronic component package 520 to form a simplified System-In-Package (SIP) configuration. The SIP package 520 includes the co-packing of the high-voltage III-N device 32, the low-voltage MOSFET 30, the gate driver 12, the IC controller 11, and the start-up circuitry collectively integrated into a single package. When the package 520 is co-packed with monolithic IC device 510, the component count of the SIP package 520 can be reduced to include only two discrete electronic semiconductor components, where the first discrete component is the high-voltage III-N device 32 and the second discrete component is the monolithic IC 510. SIP Package 520 can include at least two terminals, where the first terminal is an input terminal 52 configured to be connected to an inductive component (such as the inductive component 15 of FIG. 4) and the second terminal is a common mode terminal 54 which can be configured to be connected to a circuit ground or common node. The package 520 can include a conductive structural package base, and the first and second discrete components are physically mounted to the structural package base.

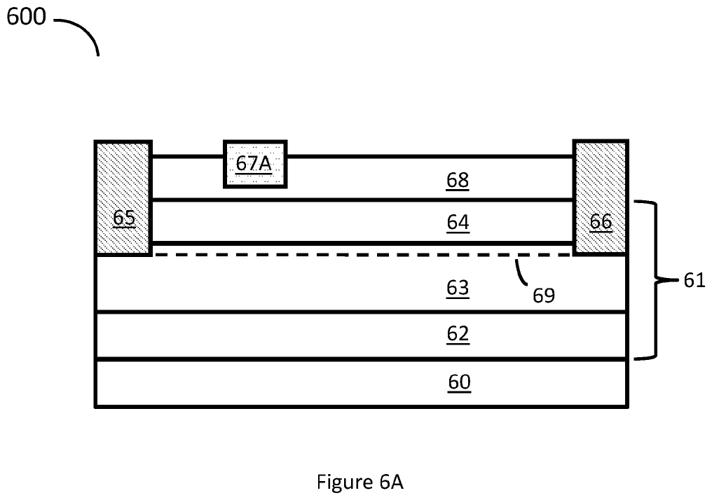

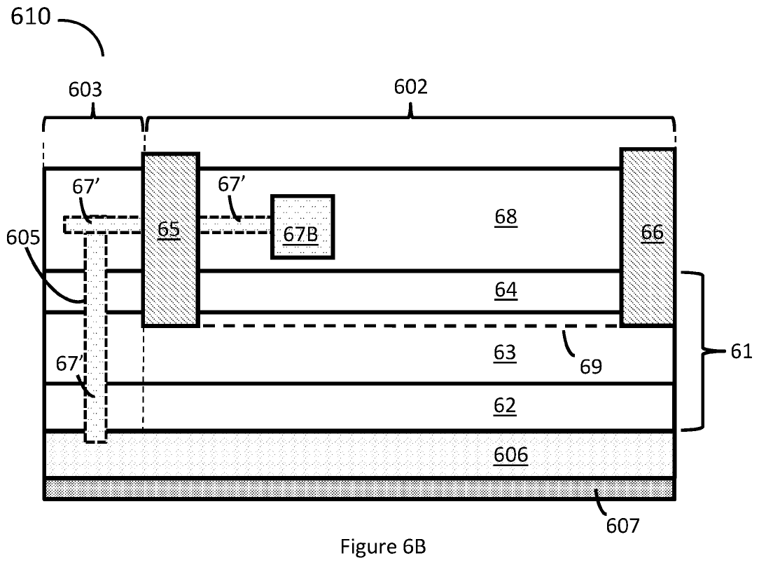

FIG. 6A shows a cross-sectional view of a depletion-mode III-N device 600 which can be used as the III-N device 32 shown in FIG. 3. III-N device 600 includes a substrate 60 which can be formed of Silicon, Sapphire, Silicon Carbide, GaN, or another appropriate material. A III-N material structure 61 is formed over the substrate 60. The III-N material structure 61 can include a III-N buffer layer 62 (e.g., AlN/AlGaN/GaN), a III-N channel layer 63 (e.g., GaN), and a III-N barrier layer 64 (e.g., AlGaN). The III-N barrier layer 64 has a higher bandgap than the III-N channel layer 63.

A compositional difference between the barrier layer 64 and the channel layer 63 causes a two-dimensional electron gas channel 69 (i.e., 2DEG channel) to be induced in a region of the channel layer 63 near the interface of the barrier layer 63. The 2DEG channel 69 can extend continuously between the source electrode 65 and the drain electrode 66 while the gate electrode 67A is biased at zero volts, such that the III-N device 600 is characterized as a depletion-mode device.

Insulating layer 68 (e.g., a SiN passivation layer or gate dielectric layer) is formed over a top surface of the III-N material structure 61 and between the gate electrode 67A and the top surface of the III-N material structure 61. The thickness of the insulating layer 68 between the gate electrode 67A and the top surface of the III-N material structure 61 can be used to tune the threshold voltage of the device, where a thicker insulating layer at that location drives the threshold voltage more negative. III-N device 600 is a lateral device, characterized such that the source electrode 65 and the drain electrode 66 are formed on the same side of the III-N material structure. As seen in FIG. 6A, each the drain electrode 66, the source electrode 65, and the gate electrode 67A include a portion the electrode which extends above the insulating layer 68 and allows for outside electrical connections to each electrode, for example, with a wire-bond.

FIG. 6B is a cross-sectional view of depletion-mode III-N device 610 which is similar to the device 600 of FIG. 6A. However, the III-N device 610 has a gate-connected substrate which allows for the gate electrode to be formed on a side of the III-N material structure opposite the source electrode and drain electrode. As seen in in FIG. 6B, a gate 67B includes a metal portion 67′ which extends outside a device active region 602 (i.e., the active region is between the source and drain) into an inactive region 603 which is electrically isolated from the 2DEG channel 69, for example, by an ion-implantation step. A via-hole 605 is formed through the III-N material structure to a surface of the substrate 606. Substrate 606 can be an electrically conductive substrate silicon substrate such as a p+ or n+ doped substrate. The metal portion 67′ of gate 67B is formed in the via-hole 605 in the inactive region 603 and contacts the conductive substrate 606. A metal layer is formed on a side the backside of the substrate to form the gate electrode 607.

If an insulating substrate is used, such as a sapphire substrate, the via-hole 605 can extend through the entire thickness of the substrate (not shown) and the metal portion 67′ can be formed in the via-hole 605 and electrically connect to the metal layer formed on the backside of the substrate. Source electrode 65 and drain electrode 66 are formed on a first side of the III-N material structure 61 and the gate electrode 607 is formed on a second side opposite the first side. When the III-N device 610 is implemented as the depletion-mode III-N device 32 in FIG. 3, the packaging complexity is reduced by eliminating the need for a gate connected wire-bond.

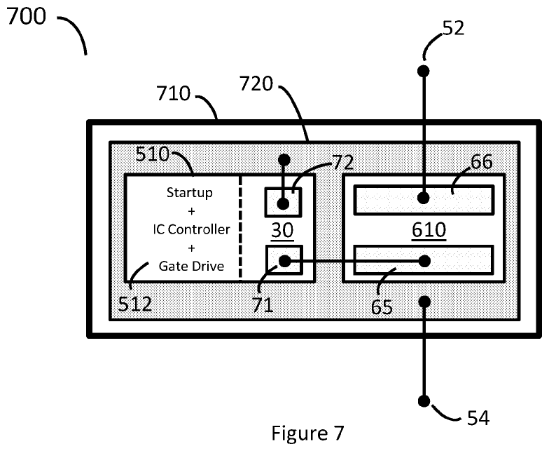

FIG. 7 is a plan view of an electronic component 700, such as electronic module or package which contains multiple semiconductor devices within. Electronic component 700 includes an electronic component package 710, which can be similar to the system-in package (SIP) 520 described previously in FIG. 5, and includes a conductive structural package base 720. The electronic component 700 includes as few as two discrete semiconductor devices. The first discrete semiconductor device is a high-voltage depletion-mode device. In the electronic component 700, the III-N device 610 of FIG. 6B is used to form the high-voltage depletion-mode transistor 32, shown in FIG. 5. The second discrete semiconductor device is a low-voltage enhancement-mode device monolithically integrated with an IC controller and date driver. In component 700, the monolithic IC 510 shown in FIG. 5 can be used as the second discrete semiconductor device.

Monolithic IC 510 shown in FIG. 7 can include a first portion which comprises the low-voltage enhancement-mode transistor 30 and a second portion 512 which includes the required components for the startup, the IC controller, and the gate driver. The component 700 includes at least a first terminal 52 (which can be configured to be connected to an inductive component) extending from the package 520 and is electrically connected to the drain electrode 66 of the III-N device 610. The conductive structural package base 710 can be configured to be connected to a common mode or circuit ground. A second terminal 54 (which can be configured to be connected to a common mode or system ground) extends from the package 520 and is electrically connected to the package base 520.

The substrate of the depletion-mode III-N device 610 is directly mounted and electrically connected to the package base 520 such that the gate electrode 607 of device 610 is electrically connected to the package base 520. Enhancement-mode device 30 can be a lateral MOSFET device, such as a LDMOS type device, where both the source electrode and the drain electrode are formed on the same side of the device (i.e., the top side). In this case, the source electrode 65 of III-N device 610 can be electrically connected to the drain electrode 71 of enhancement-mode device 30 with e.g., a wire-bond. In another embodiment, the an LDMOS type device can be used where the source electrode is formed on a bottom side (not shown) of the device opposite the drain electrode, so that the source can be directly electrically connected and physically mounted to the package conductive structural base. The source electrode 71 of device 30 can be connected to the conductive package base 520 with a wire-bond. The monolithic IC 510 includes a second portion 512 where portion 512 includes the integrated circuits used to form the startup circuitry, the IC controller, and the gate driver. The startup circuitry can be powered by and electrically connected to the drain electrode 71 through internal metal routing connections. The PWM of the IC controller and gate driver can be connected to the gate electrode of the enhancement-mode device 30 through internal metal routing connections.

The efficiency and manufacturing assembly requirements for a switched power supply can be greatly improved when implemented with the system-in-package solution such as the integrated electronic component 700 shown in FIG. 7 or with the circuit schematics shown in FIGS. 4, 5, and 6A-6B. Overall component count is reduced as well as cost. System “offline” efficiency are improved by eliminating active components used in start-up power supplies.

A number of implementations have been described. Nevertheless, it will be understood that various modifications may be made without departing from the spirit and scope of the techniques and devices described herein. Accordingly, other implementations are within the scope of the following claims.

What is claimed is:

1. An electronic component, comprising:
a semiconductor device package comprising
a conductive structural package base, a first terminal configured to be connected to an inductive load, and a second terminal configured to be connected to a common node or circuit ground,
a depletion-mode III-N transistor having a drain, a source, and a gate,
an enhancement-mode transistor having a drain, a source, and a gate
an IC controller, and
a gate driver;
wherein the drain of the depletion-mode III-N transistor is electrically connected to the first terminal, the source of the depletion-mode III-N transistor is electrically connected to the drain of the enhancement-mode transistor, the gate of the depletion-mode III-N transistor is electrically connected to the conductive structural package base, the source of the enhancement-mode transistor is electrically connected to the conductive structural package base, and wherein the enhancement-mode transistor is monolithically integrated with the IC controller and the gate driver on a common silicon substrate;
a rectifying diode having an anode connected to the drain of the enhancement-mode transistor and a cathode connected to a voltage input terminal of the IC controller; and
a reservoir capacitor having a positive side connected to the cathode of the rectifying diode and a negative side connected to the conductive structural package base.

2. The electronic component of claim 1, wherein the rectifying diode and reservoir capacitor form an IC startup circuit, and the IC startup circuit is monolithically integrated with the enhancement-mode transistor on the common silicon substrate.

3. The electronic component of claim 1, wherein the depletion-mode III-N transistor is a high voltage GaN HEMT with a breakdown voltage of greater than 600V and a gate-to-source threshold voltage of −15V or less.

4. The electronic component of claim 3, wherein the enhancement-mode transistor is a low-voltage silicon MOSFET device with a breakdown voltage greater than the absolute value of the depletion-mode transistors threshold voltage.

5. The electronic component of claim 1, wherein the source electrode and the drain electrode of the depletion-mode transistor are on an first side of a III-N material structure over an electrically conductive substrate, and the gate electrode is on a second side of the III-N material structure opposite the first side.

6. The electronic component of claim 5, wherein the gate electrode is electrically connected to the conductive structural package base through the electrically conductive substrate of the depletion-mode III-N transistor.

7. The electronic component of claim 4, wherein the IC controller further comprises a ground terminal connected to the conductive structural package base, a current sense terminal electrically connected to the source electrode of the enhancement-mode transistor, and a gate drive terminal connected to the gate electrode of the enhancement-mode transistor.

8. The electronic component of claim 7, wherein when the first terminal of the package is biased at a voltage greater than 300V, the second terminal of the package is connected to circuit ground, and the electronic component is in the OFF state, the drain of the enhancement-mode transistor maintains a positive voltage between +15V to +25V relative to the source electrode of the enhancement-mode transistor, and a startup voltage is provided to the IC controller from the drain of the enhancement-mode transistor.

9. The electronic module of claim 7, wherein the rectifying diode is not a Zener diode.

10. An electronic circuit, comprising;
a high-voltage depletion-mode transistor having a gate, a source, a drain, and a threshold voltage;
a low-voltage enhancement-mode transistor having a gate, a source, and a drain, wherein the drain of the low-voltage enhancement-mode transistor is electrically connected to the source of the depletion-mode transistor, the gate of the depletion-mode transistor is electrically connected to the source of the enhancement-mode transistor, and the source of the enhancement-mode transistor is configured to be connected to a circuit ground;
an inductive component having a first winding electrically configured to be connected to a high-voltage supply and a second winding electrically connected to the drain of the high-voltage depletion-mode transistor;
an IC controller comprising at least four pins, wherein the first pin is a voltage input pin, the second pin provides a pulse-width modulation output signal, the third pin is a current sense pin electrically connected to the source of the enhancement-mode transistor, and the fourth pin is configured to be electrically connected to the circuit ground;
a gate driver comprising an input connected to the second pin and an output connected to the gate of the enhancement-mode transistor;
a diode having an anode electrically connected to the drain of the enhancement-mode transistor and a cathode electrically connected to the IC controller voltage input pin; and
a capacitor having a positive side electrically connected to the cathode of the diode and a negative side electrically configured to be connected to the circuit ground, wherein the enhancement-mode transistor, the IC controller, the gate driver, the diode, and the capacitor are monolithically integrated in to a discrete semiconductor IC device.

11. The electronic circuit of claim 10, wherein the discrete semiconductor IC device is a silicon based device and the depletion-mode transistor is a GaN HEMT device.

12. The electronic circuit of claim 11, wherein a threshold voltage of the GaN HEMT device is −12V or less.

13. The electronic circuit of claim 12, wherein the high-voltage depletion mode transistor is configured such that when the high-voltage depletion mode transistor is in the OFF state and blocking the high-voltage supply, a drain-to-source voltage of the enhancement-mode transistor is maintained within 2V of the absolute value of the threshold voltage of the high-voltage depletion-mode transistor.

14. The electronic circuit of claim 13, a coupling between the voltage input pin of the IC controller and the drain of the enhancement-mode transistor such that a voltage required to start-up the IC controller is supplied from said coupling when the high-voltage depletion mode transistor is in the OFF state and blocking the high-voltage supply.

15. The electronic circuit of 14, wherein the discrete semiconductor IC device and the GaN HEMT device are assembled into a single electronic component package.

16. The electronic circuit of claim 15, wherein the single electronic component package comprises a conductive structural package base, and a substrate of the discrete semiconductor IC device and a substrate of the GaN HEMT device are directly mounted and physically attached to the conductive structural package base.

17. An electronic package, comprising:
a conductive structural package base;
a first terminal and a second terminal; and
a first electronic component that includes a monolithically integrated circuit formed on a common silicon substrate, and wherein the monolithically integrated circuit includes an IC controller, a gate driver, a low-voltage enhancement-mode silicon MOSFET, and an IC controller startup circuit;
a second electronic component that includes a high-voltage depletion-mode GaN transistor with a gate-to-source threshold voltage; and
wherein a source electrode of the depletion-mode GaN transistor is electrically connected to the drain electrode of the enhancement-mode silicon MOSFET transistor, the first terminal is electrically connected to a drain electrode of the depletion-mode GaN transistor and the second terminal is electrically connected to the conductive package base, a gate electrode of the depletion-mode GaN transistor and a source electrode of the enhancement-mode silicon MOSFET transistor are electrically connected to the conductive package base, and a V_{CC} node of the IC controller is coupled to the drain electrode of the enhancement-mode silicon MOSFET within the monolithically integrated circuit.

18. The electronic package of claim 17, wherein the IC controller startup circuit comprises a diode and a capacitor coupled between the V_{CC} node and the drain electrode of the enhancement-mode silicon MOSFET.

19. The electronic package of claim 18, wherein the gate-to-source threshold voltage of the depletion-mode GaN transistor is less than −12V.

20. The electronic package of claim 19, wherein a drain-to-source voltage of the enhancement-mode silicon MOSFET is biased at +12V or more when the depletion-mode GaN transistor is biased below the gate-to-source threshold voltage of the GaN transistor.
